(19) United States
(12) Patent Application Publication
(10) Pub. No.: US 2013/0247806 A1
(43) Pub. Date: Sep. 26, 2013

(54) Hoop Docking Apparatuses And Methods

(71) Applicants: Gary Allen Gardner, Dallas, TX (US); Eileen Katherine Roche, Flower Mound, TX (US)

(72) Inventors: Gary Allen Gardner, Dallas, TX (US); Eileen Katherine Roche, Flower Mound, TX (US)

(73) Assignee: GREAT NOTIONS NEWS INC., Dallas, TX (US)

(21) Appl. No.: 13/429,038

(22) Filed: Mar. 23, 2012

(51) Int. Cl. B25B 11/00

(52) U.S. Cl. 112/475.01; 269/11; 269/303

(57) ABSTRACT

Hoop docking apparatuses and methods are provided. In one embodiment, an apparatus includes a substantially planar hoop dock having a first side and a second, opposite side. The first side of the hoop dock forms a docking recess shaped to approximately contour a portion of an embroidery hoop. The docking recess is operable to receive at least a portion of the embroidery hoop.

### TECHNICAL FIELD

The illustrative embodiments relate generally to hoop docking apparatuses and methods, and more particularly, to hoop docking apparatuses and methods usable in embroidery or other sewing applications.

### BACKGROUND

Embroidery hoops are often used to secure one or more embroiderables, such as stabilizer and/or fabric, to prepare the embroiderables for an embroidery operation. For example, after securing the embroiderables in an embroidery hoop, the embroidery hoop may be coupled to an embroidery machine so that the embroiderables can be embroidered by the machine. Current embroidery docking systems and methods may fail to adequately support embroiderables while they are being secured to an embroidery hoop, resulting in misplaced or misaligned materials. Current embroidery docking systems and methods may also be inconvenient or present operational challenges to a user when he or she is securing embroiderables in an embroidery hoop. Indeed, current embroidery docking systems and methods may suffer from other issues or drawbacks as well.

### SUMMARY

According to an illustrative embodiment, an apparatus includes a substantially planar hoop dock having a first side and a second, opposite side. The first side of the hoop dock forms a docking recess shaped to approximately contour a portion of an embroidery hoop. The docking recess is operable to receive at least a portion of the embroidery hoop.

According to another illustrative embodiment, an apparatus includes a substantially planar hoop dock having a first side and a second, opposite side. The first side of the hoop dock forms a first docking recess shaped to approximately contour a portion of a first embroidery hoop. The second side of the hoop dock forms a second docking recess shaped to approximately contour a portion of a second embroidery hoop. The first docking recess is shaped differently than the second docking recess. The first docking recess is operable to receive at least a portion of the first embroidery hoop. The second docking recess is operable to receive at least a portion of the second embroidery hoop.

According to another illustrative embodiment, a method to secure an embroiderable in an embroidery hoop includes providing a substantially planar hoop dock having a first side and a second, opposite side. The first side of the hoop dock forms a docking recess shaped to approximately contour a portion of an embroidery hoop. The method also includes inserting a first portion of the embroidery hoop at least partially is the docking recess, covering at least a portion of the first portion of the embroidery hoop with one or more embroiderables, interfacing a second portion of the embroidery hoop with the first portion of the embroidery hoop such that the one or more embroiderables are secured between the first and second portions of the embroidery hoop, and removing the embroidery hoop and the one or more embroiderables from the hoop dock.

### BRIEF DESCRIPTION OF THE DRAWINGS

FIG. 1A is a schematic, perspective view of a first side of a hoop dock according to an illustrative embodiment;

FIG. 1B is a schematic, perspective view of the second, opposite side of the hoop dock shown in FIG. 1A;

FIG. 1C is a schematic, perspective view of an example embroidery hoop that may be used with the illustrative embodiments;

FIG. 1D is a schematic, perspective view of an insert that is insertable into the docking recess shown in FIG. 1B;

FIG. 1E is a schematic, cross-sectional view of the hoop dock shown in FIG. 1B taken along line 1E-1E;

FIG. 2A is a schematic, perspective view of a hoop dock according to an illustrative embodiment;

FIG. 2B is a schematic, perspective view of a portion of an embroidery hoop being placed on the hoop dock shown in FIG. 2A;

FIG. 2C is a schematic, perspective view of an embroiderable placed on the hoop dock and embroidery hoop shown in FIG. 2B;

FIG. 2D is a schematic, perspective view of a top, or second portion of an embroidery hoop placed on the hoop, dock, embroidery hoop, and embroiderable shown in FIGS. 2A-2C; and

FIG. 3 is a flowchart of a process for securing one or more embroiderables in an embroidery hoop according to an illustrative embodiment.

### DETAILED DESCRIPTION

In the following detailed description of the illustrative embodiments, reference is made to the accompanying drawings that form a part hereof. These embodiments are described in sufficient detail to enable those skilled, in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in limiting sense, and the scope of the illustrative embodiments are defined only by the appended claims.

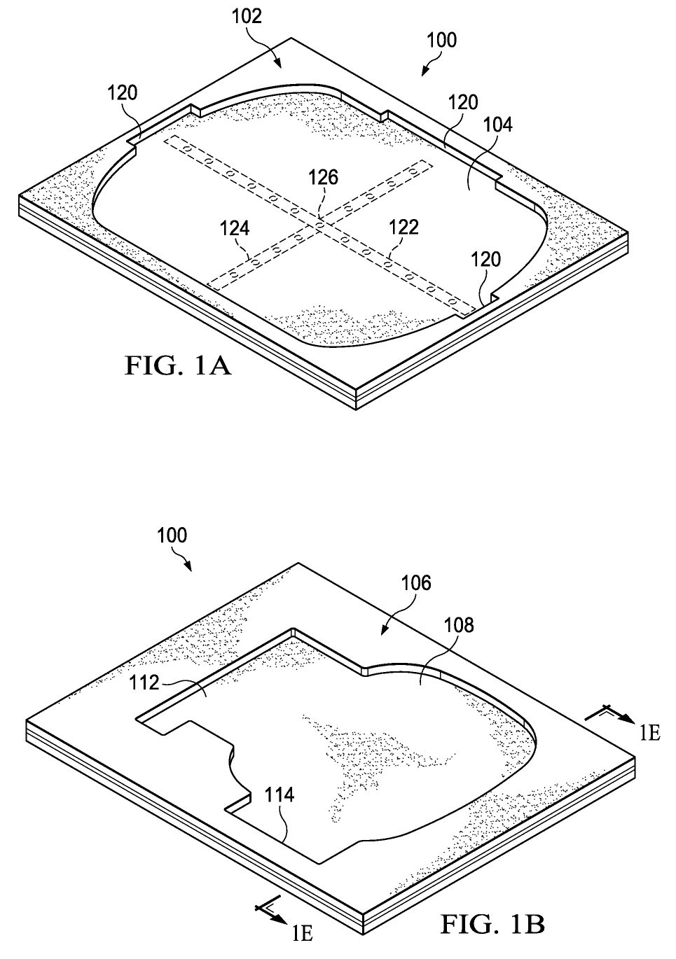

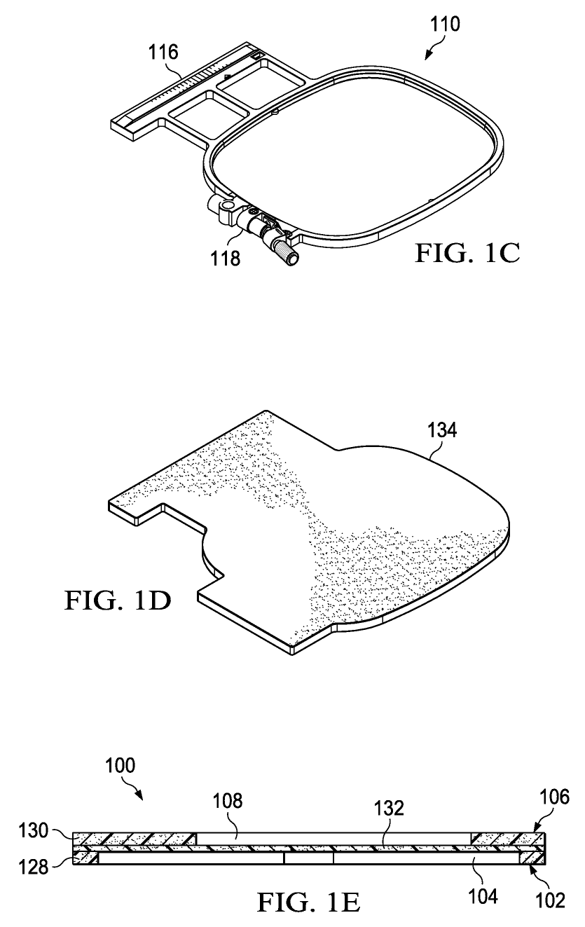

Referring to FIGS. 1A through 1E, an illustrative embodiment of a hoop dock 100 includes a first side 102 that forms a first docking recess 104, and a second, opposite side 106 that forms a second docking recess 108. Using the hoop dock 100, an embroiderable may be secured between a first, bottom portion and a second, top portion of an embroidery hoop, such as the embroidery hoop 110 shown in FIG. 1C, so that the embroiderable may be subsequently embroidered. In one embodiment, the hoop dock 100 may be used to ease, facilitate, or improve the process of securing an embroiderable to an embroidery hoop. Unless otherwise indicated, as used herein, “or” does not require mutual exclusivity.

An embroiderable includes any material capable of being sewn, embroidered, or otherwise threaded in any fashion, including, but not limited to fabric, stabilizer, paper, etc. A fabric may be composed of any type of material or substance capable of being sewn, embroidered, or otherwise threaded in any fashion, including, but not limited to, cloth, cotton, polyester, leather, synthetic material, vinyl, plastics, etc.

The first docking recess 104 on the first site 102 of the hoop dock 100 has a different shape than the second docking recess 108 on the second side 106 of the hoop dock 100. Each of the first and second docking recesses 104, 108 are shaped to approximately contour a portion (e.g., a bottom portion) of an embroidery hoop. Because the shapes of the docking recesses 104, 108 on either side 102, 106 of the hoop dock 100 are different shapes, each of the docking recesses 104, 108 may accommodate or contour embroidery hoops having different shapes, thus enabling the hoop dock 100 to be used with a larger variety of embroidery hoops.

For purposes of illustration only, the second docking recess 108 on the second side 106 of the hoop dock 100 is shaped and sized to contour or receive a first or bottom portion of the embroidery hoop 110 shown in FIG. 1C. To better secure or more accurately contour or receive the embroidery hoop 110, the second docking recess 108 may also include appendage recesses 112 and 114 to approximately contour the appendages 116, 118 of the embroidery hoop 110, respectively. More specifically, the appendage recess 112 may be shaped and sized to receive the docking appendage 116 of the embroidery hoop 110; the docking appendage 116 may be used to dock the embroidery hoop 110 to an embroidery machine. The appendage recess 114 may be shaped and sized to contour or receive a sizing appendage 118 of the embroidery hoop 110; the sizing appendage 118 may be used to adjust the size or aperture of the embroidery hoop 110. Indeed, either of the docking recesses 104, 108 may include any number of appendage recesses to contour or receive any number or variety of appendages that may be part of or coupled to an embroidery hoop 110. In yet another embodiment, either or both of the docking recesses 104, 108 may have no appendage recesses at all. In the example of FIG. 1A, the first docking recess 104 is also shown to have appendage recesses 120, which may be used to receive any type of appendage of an embroidery hoop.

As used herein, the term “coupled” may include coupling via a separate object and may also include direct coupling. The term “coupled” may also encompass two or more components that are continuous with one another by virtue of each of the components being formed from the same piece of material. Also, the term “coupled” may include chemical, such as via a chemical bond, mechanical, thermal, magnetic, or electrical coupling.

The hoop dock 100 may be made from any type of material that is suitable for providing a dock for an embroidery hoop. For example, the hoop dock 100 may be formed from a foam-like material having any foam density, including both flexible and rigid foams. Other examples of materials from which the hoop dock 100 may be formed include plastic, metal, wood, etc. The depth of each of the docking recesses 104, 108 may also vary depending on usage; one example factor that may affect the depth of each of the docking recesses 104, 108 is the type of embroidery hoop for which the respective docking recess 104, 108 is adapted to receive. Also, the hoop dock 100 is shown to have a substantially rectangular shape in FIGS. 1A and 1B; however, the hoop dock 100 may have any shape that is suitable for any of the functions of the illustrative embodiments described herein.

The first side 102 of the hoop dock 100, and more specifically the first docking recess 104, includes a first set of light sources 122 and a second set of light, sources 124. As explained in more detail below, the light sources 122, 124 may be used to help a user guide embroiderables into proper placement or alignment in an embroidery hoop being used with the hoop dock 100 by illuminating through one or more embroiderables being placed in an embroidery hoop using the hoop dock 100. As used herein, including in the claims, the term “set” encompasses a quantity of one or more.

The light sources 122 and 124 may be embedded in the hoop dock 100, and more specifically within a surface bounding the first docking recess 104 into which an embroidery hoop is received, as shown in FIG. 1A. In another embodiment, the light sources 122, 124 may overlay or cover a portion of the hoop dock 100, as opposed to being embedded therein. Also each of the light sources 122, 124 may be a light emitting diode (LED), an incandescent bulb, or any other type of light source.

In one embodiment, the first plurality of light sources 122 may form a first line at least partially across the docking recess 104. Likewise, the second plurality of light sources 124 may form a second line at least partially across the docking recess 104. The first line formed by the first plurality of light sources 122 may be substantially perpendicular to lee second line formed by the second plurality of light sources 124, as shown in FIG. 1A. The first line and second line may intersect at an intersection point 126 that is located substantially at the center of the docking recess 104.

While a generally orthogonal configuration of the first and second pluralities of light sources 122, 124 is shown by FIG. 1A, the light sources may be arranged in any configuration that is suitable or useful for the application of embroiderables into an embroidery hoop. Also, the intersection point 126 is not limited to being located in the center of the docking recess 104, as the intersection point 126 may be located in another suitable or useful position. Furthermore, any number of light sources may be used within the docking recess 104 (e.g., 1, 4, 12, 100, etc.). While the second docking recess 108 is not shown as having one or more light sources, the second docking recess 108 may also contain light sources. Indeed, either, both, or neither of the first or second docking recesses 104, 108 may contain one or more light sources.

The light sources 122, 124 may be powered in any manner. For example, the light sources 122, 124 may be powered by a battery that may be either internal or external, to the hoop dock 100. In yet another embodiment, the hoop dock 100 is pluggable into an outlet to porovide power to the light, sources 122, 124. Alternative forms of energy to power light sources 122, 124 may also be used. It will be appreciated that, although. FIGS. 1A and 1F show the hoop dock 100 to have a docking recess 104 and 108 on each side thereon, the hoop dock 100 may also contain lust one docking recess on a single side of the hoop dock 100.

In one embodiment, the hoop dock 100 is formed by two or more layers. An example of this embodiment is shown in FIG. 1E, which is a cross-sectional view of FIG. 1F taken along line 1E-1E. The hoop clock 100 may include a first, outer layer 128 that forms the first docking recess 104. The hoop dock 100 may also include a second, outer layer 130 that forms the second docking recess 108. The hoop dock may also include a third, backing layer 132 disposed between the first layer 128 and the second layer 130 to support the first layer 128 and the second layer 130. In one embodiment, each of the layers 128, 130, 132 may be formed from a same or similar material (e.g., a foam-like materal). In yet another embodiment, each of the three layers 128, 130, 132 may be formed from different materials. In one embodiment, the backing layer 132 may be formed from a harder, or more rigid, material than the first and second layers 128, 130 to provide additional support to the first and second layers 128, for example, the backing layer 132 may be formed from a higher density foam than the foam from which the first and second layers 128, 130 is composed.

Additional or fewer layers than those shown in FIG. 1E may be used in a hoop dock 100, or, alternatively, the hoop dock 100 may formed from a single layer or material. For example, if the hoop dock 100 were to include only the first docking recess 104 but not the second docking recess 108, the hoop dock 100 may then include only layers 128 and 132, and exclude the second layer 130.

In embodiment, the hoop dock 100 may also include an insertable and/or removable insert 134, as shown in FIG. 1D. The insert 134 may be inserted into the second docking recess 108 to fill the docking recess 108 and provide structural support for the first docking recess 104 on the first side 102 of the hoop dock 100. The insert 134 is shaped and sized to fit within, the second docking recess 108 so that the second docking recess 108 is substantially filled. The insert 134 may be made from a same or similar material as the remainder of the second side 106 of the hoop dock 100, or may be formed from a different material altogether. The hoop dock 100 may also include an insert (not shown) that fits into and substantially fills the first docking recess 104 on the first side 102 of the hoop dock 100 to provide structural support for when the second side 106 of the hoop dock 100 is being used to load an embroidery hoop with an embroiderable.

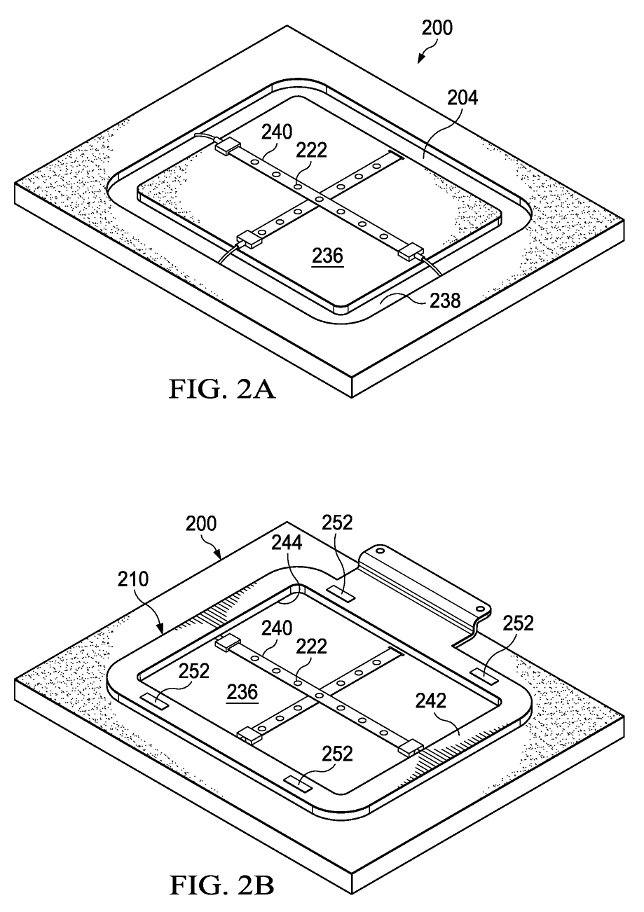

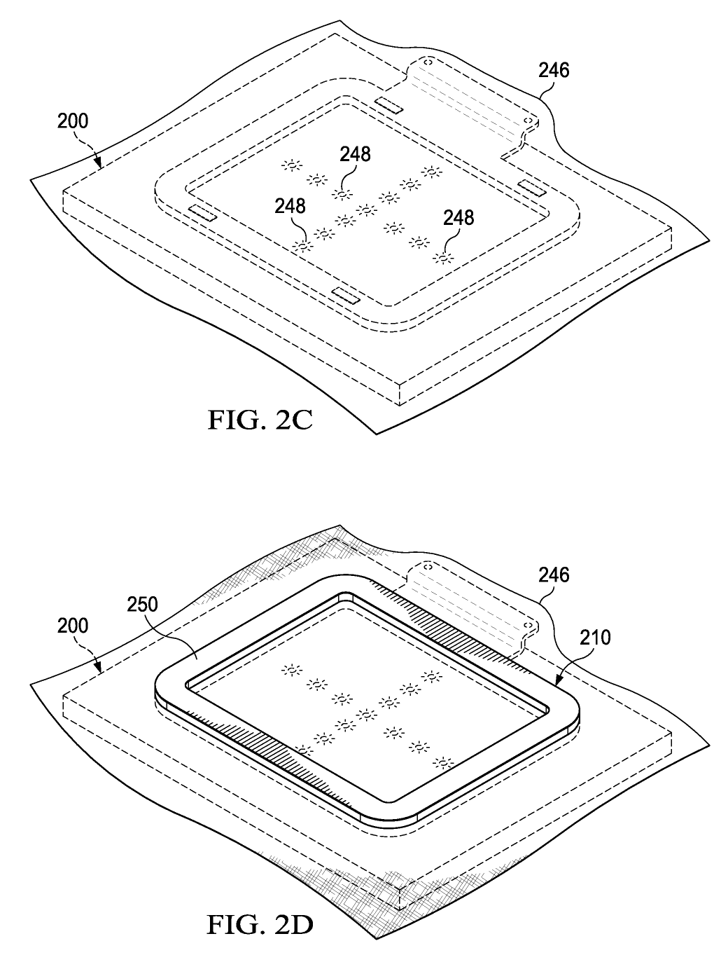

Referring to FIGS. 2A through 2D, an illustrative embodiment of the hoop dock 200 is shown to include a docking recess 204 into which a portion of an embroidery hoop 210 may be received. Elements of FIGS. 2A-D that are analogous to elements in FIGS. 1A-E have been shown by indexing the reference numerals by 100. The docking recess 204 has a different shape than the docking recesses 104, 108 shown in FIGS. 1A and 1F to accommodate the embroidery hoop 210 having a particular shape. In addition, the hoop dock 200 includes a raised plateau 236 that is substantially centrally located within the docking recess 204, and which forms a channel 238 into which a portion of the embroidery hoop 210 may be placed or secured. As will be described below, the raised plateau 236 may be shaped, positioned, or otherwise adapted to provide support to one or more embroiderables secured to the embroidery hoop 210 using the hoop dock 200.

The hoop dock 200 also includes a plurality of light sources 222, which may be linked together by an electrically conductive strip 240. The light sources 222 are located on the raised plateau 236, in this embodiment. As in the embodiment of FIGS. 1A through 1E, the light sources 222 may comprise a first and second plurality of light sources that form orthogonal lines used to center an embroiderable.

In operation, a first, or bottom, portion 242 of the embroidery hoop 210 may be inserted, at least partially, into the docking recess 204, and more specifically into the channel 238 formed between the raised plateau 236 and an outer rim of the hoop dock 200. As seen in FIG. 2B, the raised plateau 236 is sized and shaped to at least partially enter the aperture 244 of the first portion 242 of the embroidery hoop 210 when the docking recess 204 receives the first portion 242 of the embroidery hoop 210.

Next, at least a portion of the first portion 242 of the embroidery hoop 210 may be covered, with one or more embroiderables 246. For example, the first portion 242 of the embroidery hoop 210 may be covered with a stabilizer and an embroiderable material, such as fabric, onto which an embroidery pattern may be embroidered.

As can be seen in FIG. 20, light 248 from the light sources 222 passes through the embroiderable 246 so that a user is exposed to, and can use, the light 248 to guide the placement of or center the embroiderable 246 on the first portion 242 of the embroidery hoop 210. For example, the user may use the light 248 shining through the embroiderable 246 to properly center a portion of the embroiderable 246 at the center of the aperture 244 of the embroidery hoop 210. The raised plateau 236 may also act to support the embroiderable 246 prevent or reduce sagging into the aperture 244 of the first portion 242 of the embroidery hoop 210.

A second, or top, portion 250 of the embroidery hoop 210 may be interfaced with the first portion 242 of the embroidery hoop 210 such that the embroiderable 246 is secured between the first and second portions 242, 250 of the embroidery hoop 210, as shown in FIG. 2D. In the examples of FIGS. 2A through 2D, the second portion 250 of the embroidery hoop 210 is magnetically attracted to magnets 252 in the first portion 242 of the embroidery hoop 210. The second portion 250 of the embroidery hoop 210 may contain, some metal for this purpose. The one or more magnets 252 and the metal may be in either or both portions 242, 250 of the embroidery hoop 210, and in any configuration, to facilitate coupling between the first and second portions 242, 250. The magnetic attraction between the first and second portions 242, 250 of the embroidery hoop 210 acts to secure the embroiderable 246 between the first and second portions 242, 250 of the embroidery hoop 210 so that the embroiderable 246 may be embroidered. It will be appreciated that the first and second portions 242, 250 of the embroidery hoop 210 may interface, couple, or otherwise interact in any manner, including by being snappable to one another while the embroiderable 246 is present therebetween. Indeed, the hoop dock 200 is adaptable to any type of embroidery hoop, and any type of interfacing between portions thereof to secure the embroiderable (s) 246.

After placing the second portion 250 of the embroidery hoop 210 on the embroiderable 246, as shown in FIG. 2D, the embroidery hoop 210 and the embroiderable 246 secured therein may be removed from the hoop dock 200, at which point it may embroidered in any fashion, including by an embroidery machine. It will be appreciated that, although the illustrative embodiments are described with respect to embroidery applications, the hoop dock 200 may also be used for other applications.

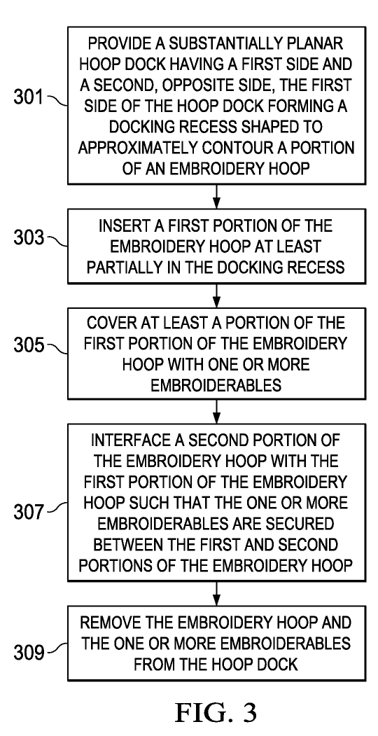

Referring to FIG. 3, an illustrative embodiment of a process for securing an embroiderable in an embroidery hoop includes providing a substantially planar hoop dock having a first side and a second, opposite side. The first side of the hoop dock may form a docking recess shaped to approximately contour a portion of an embroidery hoop (step 301). The process may include inserting a first portion of the embroidery hoop at least partially in the docking recess (step 303). The process may further include covering at least a portion of the first portion of the embroidery hoop with one or more embroiderables, such as a stabilizer and/or fabric (step 305).

The process may include interfacing a second portion of the embroidery hoop with the first portion of the embroidery hoop such that the one or more embroiderables are secured between the first and second portions of the embroidery hoop (step 307). The process may include removing the embroidery hoop and the one or more embroiderables from the hoop dock (step 309). The embroiderable may then be embroidered in any fashion.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in reverse order, depending upon the functionalty involved.

As used herein, including in the claims, the terms first, second, third, etc. . . . used in relation to an element first portion, second portion, etc.) are for reference or identification purposes only, and these terms, unless otherwise indicated, are not intended to describe or suggest a number, order, source, purpose, or substantive quality for any element for which such a term is used.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. An apparatus comprising:
a substantially planar hoop dock having a first side and a second, opposite side, the first side of the hoop dock forming a docking recess shaped to approximately contour a portion of an embroidery hoop;
wherein the docking recess is operable to receive at least a portion of the embroidery hoop.

2. The apparatus of claim 1, wherein the docking recess includes one or more appendage recesses, each of the one or more appendage recesses shaped to approximately contour an appendage of the embroidery hoop.

3. The apparatus of claim 2, wherein one or more appendage recesses are shaped to approximately contour one of a docking appendage or a sizing appendage of the embroidery hoop.

4. The apparatus of claim 1, wherein the hoop dock further comprises a raised plateau adapted to support one or more embroiderables, the raised plateau substantially centrally located within the docking recess.

5. The apparatus of claim 4, wherein the raised plateau is sized and shaped to at least partially enter an aperture of the embroidery hoop when the docking recess receives the at least a portion of the embroidery hoop.

6. The apparatus of claim 1, wherein the hoop dock is substantially made from a foam-like material.

7. The apparatus of claim 1, wherein the hoop dock comprises:
a first, outer layer forming the docking recess; and
a second, backing layer to support the first layer.

8. The apparatus of claim 1, wherein the hoop dock comprises:
one or more light sources in the docking recess of the hoop dock.

9. The apparatus of claim 8, wherein the or more light sources comprise:
a first plurality of light sources forming a first line at least partially across the docking recess; and
a second plurality of light sources forming a second line at least partially across the docking recess;
wherein the first line is perpendicular to the second line; and
wherein the first line intersects the second line at an intersection point, the intersection point located at substantially center of the docking recess.

10. The apparatus of claim 8, wherein each of the one or more light sources is a light emitting diode (LED).

11. The apparatus of claim 8, wherein each of the one or more light sources is embedded in the hoop dock.

12. The apparatus of claim 8, wherein each of the one or more light sources is adapted to illuminate through one or more embroiderables.

13. The apparatus of claim 1, wherein the embroidery hoop comprises a first hoop portion interfacable with a second hoop portion to secure one or more embroiderables between the first hoop portion and the second hoop portion; and
wherein the docking recess is operable to receive at least a portion of one of the first hoop portion or the second hoop portion.

14. An apparatus comprising:
a substantially planar hoop dock having a first side and a second, opposite side, the first side of the hoop dock forming a first docking recess shaped to approximately contour a portion of a first embroidery hoop, the second side of the hoop dock forming a second docking recess shaped to approximately contour a portion of a second embroidery hoop, the first docking recess shaped differently than the second docking recess;
wherein the first docking recess is operable to receive at least a portion of the first embroidery hoop; and
wherein the second docking recess is operable to receive at least a portion of the second embroidery hoop.

15. The apparatus of claim 14, wherein the apparatus further comprises:
an insert shaped and sized to substantially fill one of the first docking recess or the second docking recess, the insert adapted to provide structural support to the hoop dock while the other of the first docking recess or the second docking recess is in use.

16. The apparatus of claim 14, wherein the hoop dock comprises:
a first, outer layer forming the first docking recess;
a second, outer layer forming the second docking recess; and
a third, backing layer disposed between the first layer and the second layer to support the first layer and the second layer.

17. The apparatus of claim 14, wherein the apparatus further comprises:
one or more light sources located in at least one of the first docking recess or the second docking recess.

18. A method to secure an embroiderable in an embroidery hoop, the method comprising:
providing a substantially planar hoop dock having a first side and a second, opposite side, the first side of the hoop dock forming a docking recess shaped to approximately contour a portion of an embroidery hoop;
inserting a first portion of the embroidery hoop at least partially in the docking recess;
covering at least a portion of the first portion of the embroidery hoop with one or more embroiderables;
interfacing a second portion of the embroidery hoop with the first portion of the embroidery hoop such that the one or more embroiderables are secured between the first and second portions of the embroidery hoop; and
removing the embroidery hoop and the one or more embroiderables from the hoop dock.

19. The method of claim 18, wherein covering at least a portion of the first portion of the embroidery hoop with the one or more embroiderables comprises guiding placement of the one or more embroderables on the first portion of the embroidery hoop using one or more light sources coupled to the hoop dock.

20. The method of claim 18, wherein covering at least a portion of the first portion of the embroidery hoop with the one or more embroiderables comprises covering at least a portion of the first portion of the embroidery hoop with a stabilizer and a fabric.
